(19) United States
(12) Patent Application Publication
(10) Pub. No.: US 2026/0251167 A1
(43) Pub. Date: Aug. 27, 2026

(54) JOINT FOR ABOVE GROUND POOL FRAME

(71) Applicant: Intex Marketing Ltd., Tortola (VG)

(72) Inventors: Hua Hsiang Lin, Fujian (CN); Yaw Yuan Hsu, Fujian (CN)

(73) Assignee: Intex Marketing Ltd., Tortola (VG)

(21) Appl. No.: 19/645,795

(22) Filed: Apr. 13, 2026

Related U.S. Application Data
(62) Division of application No. 18/620,078, filed on Mar. 28, 2024.
Application No. 18/620,078 is a continuation of application No. 18/197,788, filed on May 16, 2023, now Pat. No. 11,959,512.
Application No. 18/197,788 is a continuation of application No. 17/962,979, filed on Oct. 10, 2022, now Pat. No. 11,692,573.
Application No. 17/962,979 is a continuation of application No. 16/220,484, filed on Jun. 16, 2017, now Pat. No. 11,692,572.

(30) Foreign Application Priority Data
Jun. 17, 2016 (CN) 201620598406.9
Jun. 22, 2016 (CN) 201630270359.0
Sep. 6, 2016 (CN) 201621039473.3

(51) Int. Cl. F16B 7/14; A63C 19/02; E04H 4/00; E04H 4/14; F16B 7/04

(52) U.S. Cl. CPC F16B 7/14; A63C 19/02; E04H 4/0056; E04H 4/14; F16B 7/042; F16B 7/0446

(57) ABSTRACT

A frame pool is disclosed including a frame assembly and a pool liner, the frame assembly including horizontal frame members and a vertical frame member coupled together via a T-shaped joint. The T-shaped joint may be constructed of plastic to facilitate attachment and detachment to the adjacent frame members and to resist galling and corrosion. The T-shaped joint may also be relatively small to improve the appearance and water containment of the frame pool.

### CROSS REFERENCE TO RELATED APPLICATIONS

The present application claims priority to the following Chinese patent applications, the disclosures of which are hereby expressly incorporated by reference herein in their entirety:

| application Ser. No. | Filing Date |
|---|---|
| CN 201620598406.9 | Jun. 17, 2016 |
| CN 201630270359.0 | Jun. 22, 2016 |
| CN 201621039473.3 | Sep. 6, 2016 |

### FIELD OF THE DISCLOSURE

The present disclosure relates to an above ground pool. More particularly, the present disclosure relates to a joint for an above ground pool, and to a method for using the same.

### BACKGROUND OF THE DISCLOSURE

A frame pool may include a frame assembly and a pool liner supported by the frame assembly to form a water cavity of the pool. The frame assembly may include one or more horizontal frame members (e.g., horizontal pipes) that form an upper rim of the pool and one or more vertical frame members (e.g., vertical pipes) that extend downward from the horizontal frame members to the ground. To allow the frame assembly to be disassembled for storage and assembled for use, the horizontal frame members and the vertical frame members may be removably coupled together via a plurality of T-shaped joints. Existing T-shaped joints are formed of metal, which may be susceptible to galling and corrosion, especially as any protective coating on the metal becomes worn or damaged. Also, existing T-shaped joints are relatively wide, so existing pool liners may require wide holes or gaps to accommodate such T-shaped joints, which may impact the pool's appearance and ability to contain water.

### SUMMARY

The present disclosure provides a frame pool including a frame assembly and a pool liner, the frame assembly including horizontal frame members and a vertical frame member coupled together via a T-shaped joint. The T-shaped joint may be constructed of plastic to facilitate attachment and detachment to the adjacent frame members and to resist galling and corrosion. The T-shaped joint may also be relatively small to improve the appearance and water containment of the frame pool.

According to an embodiment of the present disclosure, a frame joint is disclosed for an above ground pool frame having a first horizontal frame member, a second horizontal frame member, and a vertical frame member. The frame joint includes: a first horizontal joint portion including a first coupling assembly configured to couple with the first horizontal frame member; a second horizontal joint portion including a second coupling assembly configured to couple with the second horizontal frame member; and a vertical joint portion fixedly coupled to the first and second horizontal joint portions and configured to couple with the vertical frame member; wherein a width of the vertical joint portion accounts for at least 50% of a width between the first and second coupling assemblies of the first and second horizontal joint portions.

According to another embodiment of the present disclosure, a frame joint is disclosed for an above ground pool frame having a first horizontal frame member, a second horizontal frame member, and a vertical frame member. The frame joint includes: a first horizontal joint portion configured to couple with the first horizontal frame member, the first horizontal joint portion being constructed of plastic; a second horizontal joint portion configured to couple with the second horizontal frame member, the second horizontal joint portion being constructed of plastic; and a vertical joint portion fixedly coupled to the first and second horizontal joint portions and configured to couple with the vertical frame member, the vertical joint portion being constructed of plastic.

According to yet another embodiment of the present disclosure, a method is disclosed for assembling an above ground pool. The method includes: coupling a first horizontal joint portion of a frame joint to a first horizontal frame member with a first coupling assembly; coupling a second horizontal joint portion of the frame joint to a second horizontal frame member with a second coupling assembly; and coupling a vertical joint portion of the frame joint to a vertical frame member, wherein a width of the vertical joint portion accounts for a majority of a width between the first and second coupling assemblies of the first and second horizontal joint portions.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a partial perspective view of a frame pool including a frame assembly and a pool liner, the frame assembly including horizontal frame members and a vertical frame member coupled together via an exemplary T-shaped joint of the present disclosure;

FIG. 2 is an exploded perspective view of the frame assembly of FIG. 1;

FIG. 3 is an exploded perspective view of the T-shaped joint of FIG. 1; and

FIG. 4 is an assembled cross-sectional view of the T-shaped joint of FIG. 3.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

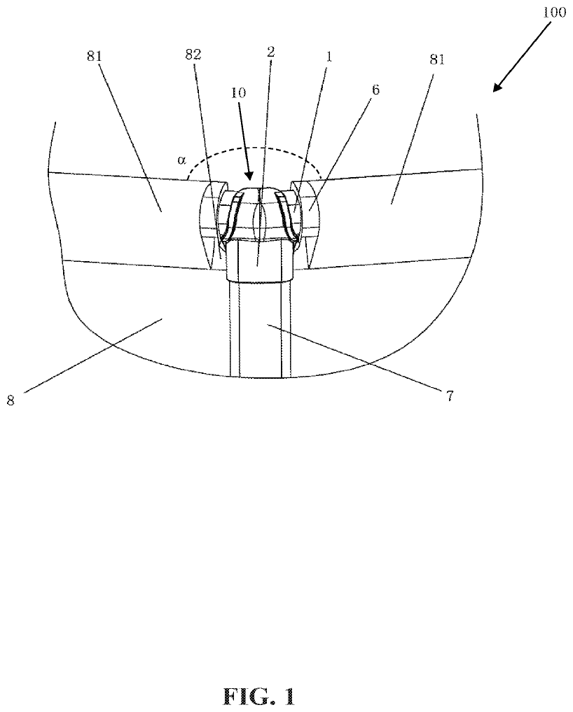

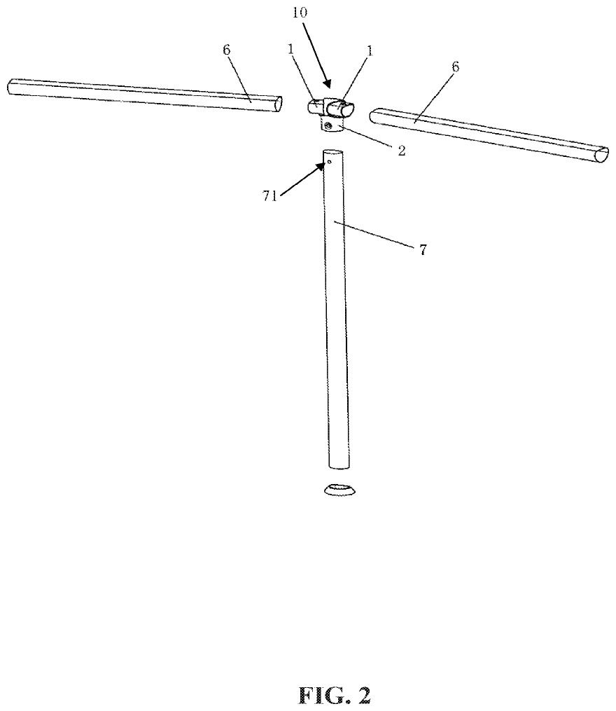

A portion of an exemplary frame pool 100 is shown in FIGS. 1 and 2. The illustrative portion of the frame pool 100 includes two adjacent horizontal frame members 6 (e.g., horizontal pipes) that cooperate to form an upper rim of the frame pool 100 and a vertical frame member 7 (e.g., vertical pipe) that extends downward from the horizontal frame members 6 to support the frame pool 100 on the ground. Although not shown in FIGS. 1 and 2, similar frame members 6 and 7 may be provided around the remaining perimeter of the frame pool 100. The frame pool 100 may vary in size and shape. For example, the frame pool 100 may be rectangular, circular, elliptical, or other suitable shapes.

Referring still to FIGS. 1 and 2, a T-shaped joint 10 may be used to removably couple the two adjacent horizontal frame members 6 to the adjacent vertical frame member 7. Although a single T-shaped joint 10 is shown in FIGS. 1 and 2, similar T-shaped joints 10 may be provided around the remaining perimeter of the frame pool 100. Each T-shaped joint 10 illustratively includes two horizontal joint portions 1 configured to couple to the horizontal frame members 6 and a vertical joint portion 2 configured to couple to the vertical frame member 7. To form the T-shape, the vertical joint portion 2 is centered between and perpendicular to the two horizontal joint portions 1. The orientation of the horizontal joint portions 1 determines the orientation of the adjacent horizontal frame members 6. In the illustrated embodiment of FIG. 1, for example, the horizontal joint portions 1 define an obtuse angle α therebetween, so the horizontal frame members 6 define the same angle α therebetween. In another embodiment, the horizontal joint portions 1 may be collinear with each other, so the horizontal frame members 6 would also be collinear with each other. In another embodiment, the horizontal joint portions 1 may be perpendicular to each other, so the horizontal frame members 6 would also be perpendicular to each other, such as along a corner of a rectangular frame pool 100.

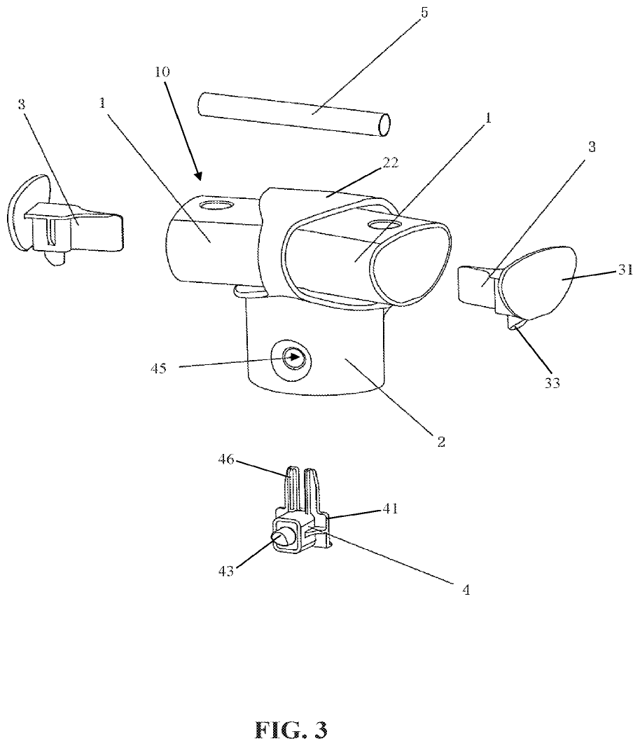

Some or all components of the frame assembly, including the horizontal frame members 6, the vertical frame members 7, and/or the T-shaped joints 10, may be constructed of a polymer, specifically plastic, such as by injection molding. Compared to metallic components, the plastic components may be smooth and elastic to facilitate assembly and disassembly of the frame assembly. Also, the plastic components may be more resistant to galling and corrosion to promote extended use. With respect to the T-shaped joint 10, in particular, the horizontal joint portions 1 and the vertical joint portion 2 may be integrally formed as a single piece of plastic. Alternatively, the horizontal joint portions 1 and the vertical joint portion 2 may be formed as multiple pieces of plastic and then fixedly coupled (e.g., adhered, welded) together. The upper end of the T-shaped joint 10 may include a raised rim 22 (FIG. 3) to give the appearance that the vertical joint portion 2 wraps around the horizontal joint portions 1.

The illustrative frame pool 100 of FIG. 1 also includes a pool liner 8 supported by the frame members 6 and 7 to form an interior water cavity for swimming and/or bathing. The pool liner 8 may be wrapped and secured around the horizontal frame member 6 to form a loop or fold 81. The fold 81 of the pool liner 8 may also define a gap or hole 82 to expose the T-shaped joint 10, as described further below.

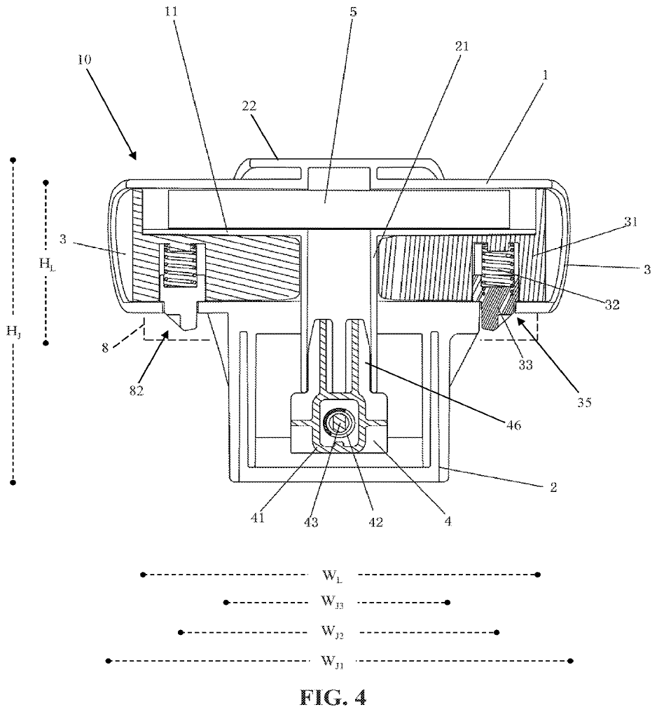

The illustrative T-shaped joint 10 is described in more detail with reference to FIGS. 3 and 4.

The horizontal joint portions 1 of the illustrative T-shaped joint 10 are configured to couple with the adjacent horizontal frame members 6 (FIG. 2). The horizontal joint portions 1 may be configured to fit within the adjacent horizontal frame members 6 in a sleeved manner. Thus, the external cross-section of the horizontal joint portions 1 may match the internal cross-section of the horizontal frame members 6. In the illustrated embodiment of FIG. 3, the external cross-section of the horizontal joint portions 1 is generally triangular with rounded edges to resist rotation between the horizontal joint portions 1 and the horizontal frame members 6. It is also within the scope of the present disclosure for the external cross-section to be circular, rectangular, elliptical, or another suitable shape to match the internal cross-section of the horizontal frame members 6.

Each horizontal joint portion 1 of the T-shaped joint 10 includes a coupling assembly 3 for removable attachment to the adjacent horizontal frame member 6 (FIG. 2). As shown in FIGS. 3 and 4, each coupling assembly 3 includes a base 31 received in the horizontal joint portion 1, a helical spring 32 held in place by the base 31, and a pin 33 extending radially outward (e.g., downward) through a hole 35 in the horizontal joint portion 1. Each horizontal joint portion 1 may include an internal horizontal reinforcing rib 11 and/or an internal horizontal support member 5 to help support base 31 within the T-shaped joint 10. In an assembled or locked state, spring 32 may bias pin 33 radially outward through hole 35 to engage a corresponding recess or hole (not shown) of the horizontal frame member 6 (FIG. 2). In a disassembled or unlocked state, a user may press pin 33 radially inward to compress spring 32 and disengage the horizontal frame member 6 (FIG. 2).

The vertical joint portion 2 of the illustrative T-shaped joint 10 is configured to couple with the adjacent vertical frame member 7 (FIG. 2). The vertical joint portion 2 may be configured to fit within the adjacent vertical frame member 7 in a sleeved manner. Thus, the external cross-section of the vertical joint portion 2 may match the internal cross-section of the vertical frame member 7. In the illustrated embodiment of FIG. 3, the external cross-section of the vertical joint portion 2 is generally triangular with rounded edges to resist rotation between the vertical joint portion 2 and the vertical frame member 7. It is also within the scope of the present disclosure for the external cross-section to be circular, rectangular, elliptical, or another suitable shape to match the internal cross-section of the vertical frame member 7.

The vertical joint portion 2 of the T-shaped joint 10 includes a coupling assembly 4 for removable attachment to the adjacent vertical frame member 7 (FIG. 2). As shown in FIGS. 3 and 4, each coupling assembly 4 includes a base 41 received in the vertical joint portion 2, a helical spring 42 held in place by the base 41, and a pin 43 extending radially outward (e.g., rearward) through a hole 45 in the vertical joint portion 2. The vertical joint portion 2 may include one or more internal vertical reinforcing ribs 21 to help support base 41 within the T-shaped joint 10, such as by compressing fingers 46 of base 41 together within the T-shaped joint 10. In an assembled or locked state, spring 42 may bias pin 43 radially outward through hole 45 to engage a corresponding recess or hole 71 of the vertical frame member 7 (FIG. 2). In a disassembled or unlocked state, a user may press pin 43 radially inward to compress spring 42 and disengage the hole 71 of the vertical frame member 7 (FIG. 2).

According to an exemplary embodiment of the present disclosure, and as shown in FIG. 4, the size of the T-shaped joint 10 may be minimized such that the size of the corresponding hole 82 in the pool liner 8 (shown in phantom) may also be minimized. The small hole 82 in the pool liner 8 may improve the appearance and water containment of the frame pool 100 (FIG. 1) while still leaving the coupling assemblies 3 and 4, specifically the pins 33 and 43 of the coupling assemblies 3 and 4, accessible for subsequent disassembly.

The width of the T-shaped joint 10 may be minimized such that the width of the corresponding hole 82 in the pool liner 8 may also be minimized. For example, the total width Wji of the T-shaped joint 10 may be about 5 inches to about 7 inches, specifically about 5¾ inches, the width W_{J2} between the pins 33 of the coupling assemblies 3 may be about 3 inches to about 5 inches, specifically about 3 13/16 inches, and the width W_{J3} of the vertical joint portion 2 may be about 1 inches to about 3 inches, specifically about 2⅜ inches. In the illustrated embodiment of FIG. 4, the width W_{L} of the hole 82 in the pool liner 8 is greater than both the width W_{J3} of the vertical joint portion 2 and the width W_{J2} between the pins 33 to expose the pins 33 of the coupling assemblies 3 for subsequent disassembly while being less than the total width W_{J1} of the T-shaped joint 10. For example, the width W_{L} of the hole 82 in the pool liner 8 is about 3 inches to about 7 inches, specifically about 4½ inches.

To help minimize the size of the T-shaped joint 10, the pins 33 of the coupling assemblies 3 may be positioned close to the vertical joint portion 2. Due to this close positioning, the width W_{J3} of the vertical joint portion 2 may account for a majority of the width W_{J2} between the pins 33 of the coupling assemblies 3. For example, the width W_{J3} of the vertical joint portion 2 may account for 50%, 60%, 70%, 80%, or more of the width W_{J2} between the pins 33 of the coupling assemblies 3. In the illustrated embodiment of FIG. 4, in particular, the width W_{J3} of the vertical joint portion 2 accounts for about 70% of the width W_{J2} between the pins 33 of the coupling assemblies 3. The width W_{J3} of the vertical joint portion 2 may also account for a significant portion of the total width W_{J1} of the T-shaped joint 10. For example, the width W_{J3} of the vertical joint portion 2 may account for 40%, 50%, 60%, 70%, or more of the total width W_{J1} of the T-shaped joint 10. In the illustrated embodiment of FIG. 4, in particular, the width W_{J3} of the vertical joint portion 2 accounts for about 50% of the of the total width W_{J1} of the T-shaped joint 10.

Additionally, the height of the T-shaped joint 10 may be minimized such that the height of the corresponding hole 82 in the pool liner 8 may be minimized. For example, the total height H_{J} of the T-shaped joint 10 may be about 3 inches to about 5 inches, specifically about 3⅞ inches. Because the pin 43 of the coupling assembly 4 may be accessible in front of the pool liner 8 and behind the T-shaped joint 10, the hole 82 in the pool liner 8 need not extend downward beneath the pin 43. Thus, in the illustrated embodiment of FIG. 4, the height H_{L} of the hole 82 in the pool liner 8 is less than the total height H_{J} of the T-shaped joint 10 while still allowing access to the pin 33 of the coupling assembly 3 and the pin 43 of the coupling assembly 4 for subsequent disassembly.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-20. (canceled)

21. A method of assembling an above ground pool, the method comprising:
(a) moving at least one of a first frame member having a first radial opening spaced apart from an open end of the first frame member and a first joint portion of a frame joint towards each other along a first direction, the first joint portion including an outer wall defining an interior and an open end, a first base of the first joint portion located entirely within the interior of the outer wall spaced apart from the open end of the outer wall, a first pin being received within a guide of the first base and movable relative to the first base in a second direction, the first pin being biased towards the outer wall by a first helical spring;
(b) by continuing to move the at least one of first frame member and the first joint portion towards each other along the first direction, placing the first frame member and the outer wall of the first joint portion in an overlapping relationship; and
(c) subsequent to step (b) by continuing to move the at least one of first frame member and the first joint portion towards each other along the first direction, aligning the first radial opening of the first frame member with a first radial opening in the outer wall of the first joint portion such that the first pin under the bias of the first helical spring is received in the first radial opening of the first frame member and the first radial opening in the outer wall of the first joint portion.

22. The method of claim 21, wherein the outer wall of the first joint portion is shaped to resist rotation between the first joint portion and the first frame member.

23. The method of claim 22, wherein a perimeter of the outer wall of the first joint portion is substantially elliptical.

24. The method of claim 22, wherein a perimeter of the outer wall of the first joint portion has a continuous slope.

25. The method of claim 23, wherein the perimeter of the outer wall of the first joint portion is an outer perimeter of the outer wall of the first joint portion.

26. The method of claim 21, wherein the open end of the first frame member is shaped to resist rotation between the first joint portion and the first frame member.

27. The method of claim 26, wherein a perimeter of the open end of the first frame member is substantially elliptical.

28. The method of claim 26, wherein a perimeter of the open end of the first frame member has a continuous slope.

29. The method of claim 21, wherein the second direction is substantially perpendicular to the first direction.

30. The method of claim 21, further comprising:
(d) moving at least one of a second frame member having a second radial opening spaced apart from an open end of the second frame member and a second joint portion of the frame joint towards each other along a third direction, the second joint portion including an outer wall defining an interior and an open end, a second base of the second joint portion located entirely within the interior of the outer wall of the second joint portion spaced apart from the open end of the outer wall of the second joint portion, a second pin being received within a guide of the second base and movable relative to the second base in a fourth direction, the second pin being biased towards the outer wall of the second joint portion by a second helical spring;
(e) by continuing to move the at least one of second frame member and the second joint portion towards each other along the third direction, placing the second frame member and the outer wall of the second joint portion in an overlapping relationship; and
(f) subsequent to step (e) by continuing to move the at least one of second frame member and the second joint portion towards each other along the third direction, aligning the second radial opening of the second frame member with a second radial opening in the outer wall of the second joint portion such that the second pin under the bias of the second helical spring is received in the second radial opening of the second frame member and the second radial opening in the outer wall of the second joint portion.

31. The method of claim 30, wherein the outer wall of the second joint portion is shaped to resist rotation between the second joint portion and the second frame member.

32. The method of claim 31, wherein a perimeter of the outer wall of the second joint portion is substantially elliptical.

33. The method of claim 31, wherein a perimeter of the outer wall of the second joint portion has a continuous slope.

34. The method of claim 30, wherein the open end of the second frame member is shaped to resist rotation between the second joint portion and the second frame member.

35. The method of claim 34, wherein a perimeter of the open end of the second frame member is substantially elliptical.

36. The method of claim 34, wherein a perimeter of the open end of the second frame member has a continuous slope.

37. The method of claim 30, wherein a horizontal width between the first pin and the second pin is about 4 inches.

38. The method of claim 30, further comprising:
(g) moving at least one of a vertical frame member and a vertical joint portion towards each other along a fifth direction to couple the vertical frame member and the vertical joint portion together.

39. The method of claim 38, wherein at least one of a perimeter of the vertical frame member and a perimeter of the vertical joint portion is shaped to resist rotation between the vertical frame member and the vertical joint portion.

40. The method of claim 38, wherein at least one of a perimeter of the vertical frame member and a perimeter of the vertical joint portion is substantially elliptical.

41. The method of claim 38, wherein at least one of a perimeter of the vertical frame member and a perimeter of the vertical joint portion has a continuous slope.

42. The method of claim 38, wherein the fifth direction is substantially parallel to the second direction and the fourth direction.

43. The method of claim 30, wherein the first direction of the first joint portion and the third direction of the second joint portion are substantially collinear with each other.

44. The method of claim 30, wherein the first direction of the first joint portion and the third direction of the second joint portion are substantially perpendicular to each other.

45. The method of claim 30, wherein the first direction of the first joint portion and the third direction of the second joint portion form an obtuse angle in a horizontal plane.

46. The method of claim 38, wherein the vertical joint portion has an outer surface, a first horizontal distance between the outer surface of the vertical joint portion and the first pin being less than a second horizontal distance between the open end of the first joint portion and the first pin.

47. The method of claim 36, wherein a third horizontal distance between the outer surface of the vertical joint portion and the second pin being less than a fourth horizontal distance between the open end of the second joint portion and the second pin.

48. The method of claim 21, wherein the first helical spring and the first pin are both received within the guide of the first base.

49. The method of claim 48, wherein the guide restricts a translational movement of the first pin within the guide along the second direction.

50. The method of claim 49, wherein the guide includes a first locator which locates a first end of the first helical spring and the first pin includes a second locator which locates a second end of the first helical spring.

51. The method of claim 50, wherein the first locator is received within the first helical spring, and the second locator receives the first helical spring.

52. The method of claim 50, wherein the first helical spring has an inner diameter and an outer diameter, the first locator being sized to fit within the inner diameter of the first helical spring, and the second locator being sized to receive the outer diameter of the first helical spring.

53. The method of claim 50, wherein the first pin includes a shoulder which cooperates with the outer wall of the first joint portion to limit a maximum separation distance between the first pin and the first locator of the guide of the first base prior to step (b).

54. The method of claim 53, further comprising (d) prior to step (c) causing the first pin to translate in the second direction towards the first locator to allow the at least one of first frame member and the first joint portion to continue to move towards each other, an outer end of the first pin contacting an inner surface of the first frame member during step (d) and extending radially outward of an external surface of the first frame member in the second direction in step (c).

55. The method of claim 54, wherein the first joint portion further includes a horizontally extending support to support the first base within the interior of the outer wall of the first joint portion.

56. The method of claim 55, wherein the horizontally extending support extends horizontally from a first location inward of the first base such that the first base is horizontally positioned between the open end of the first joint portion and the first location.

57. The method of claim 56, wherein the first joint portion further includes one or more horizontally extending reinforcing ribs and one or more vertically extending reinforcing ribs, the first base being horizontally positioned between the open end of the first joint portion and the one or more horizontally extending reinforcing ribs and the one or more vertically extending reinforcing ribs.

58. The method of claim 57, wherein the horizontally extending support extends at least between the one or more vertically extending reinforcing ribs and the first base.

59. The method of claim 21, wherein the first pin and the first helical spring are removable from the open end of the first joint portion.

60. The method of claim 21, wherein a shape of an inner perimeter of the outer wall of the first joint portion matches a shape of an outer perimeter of the outer wall of the first joint portion.

61. The method of claim 21, wherein the first base is removable from the open end of the first joint portion.

62. The method of claim 21, wherein the first frame member receives the outer wall of the first joint portion in an interior of the first frame member.

63. The method of claim 21, wherein the frame joint has an overall horizontal width of about 7 inches.
